(19) United States
(12) Patent Application Publication
(10) Pub. No.: US 2009/0277666 A1
(43) Pub. Date: Nov. 12, 2009

(54) HEAT-RESISTANT RESIN VARNISH, HEAT-RESISTANT RESIN FILMS, HEAT-RESISTANT RESIN COMPOSITES, AND INSULATED WIRE

(76) Inventors: Masa-aki Yamauchi, Osaka (JP); Masaya Kakimoto, Osaka (JP); Akira Mizoguchi, Osaka (JP); Tooru Shimizu, Osaka (JP); Masahiro Koyano, Shiga (JP); Katsufumi Matsui, Shiga (JP); Kengo Yoshida, Shiga (JP)

Correspondence Address: MCDERMOTT WILL & EMERY LLP, 600 13TH STREET, N.W., WASHINGTON, DC, 20005-3096, US

(21) Appl. No.: 12/307,310

(22) PCT Filed: Jun. 28, 2007
(86) PCT No.: PCT/JP2007/063026

§ 371 Date: Jan. 2, 2009

(30) Foreign Application Priority Data
Jul. 4, 2006 (JP) 2006-184960
Jul. 4, 2006 (JP) 2006-184962

(51) Int. Cl. H01B 7/00; C08L 79/08; B32B 1/08; H01B 3/30

(52) U.S. Cl. 174/119 C; 525/432; 428/36.9; 428/36.91; 174/120 SR; 174/110 SR

(57) ABSTRACT

A heat-resistant resin varnish characterized by comprising a polyamideimide resin whose terminal isocyanate group is blocked with a blocking agent and a polyamic acid, which is freed from viscosity increase even without employing any complicated step such as heating or cooling and which is easily applicable to a substrate and can form, through curing, films having excellent strength and elongation (toughness) equivalent to those of polyimide resin; heat-resistant resin films which are made of a heat-resistant resin formed by baking the varnish and have excellent toughness; heat-resistant composites having the heat-resistant resin films; and insulated wire which is covered with an insulating coating film made from the varnish through curing and having excellent toughness and which can be easily manufactured at a low cost.

### TECHNICAL FIELD

The present invention relates to a heat-resistant resin varnish which forms a cured product that is low in price and excellent in toughness. The present invention also relates to a heat-resistant resin film formed using the heat-resistant resin varnish, a heat-resistant resin composite containing the heat-resistant resin film as a component, and an insulated wire having an insulating covering (coating film) formed using the heat-resistant resin varnish, and is used for high-output motors for automobiles and the like, various electrical apparatuses, etc.

### BACKGROUND ART

High-output motors for automobiles whose development has been drawing attention in view of environmental problems in recent years, insulating coverings of insulated wires for use in various electrical apparatuses for which reduction in size and electrical power consumption have been demanded, insulating films for use in the above-mentioned various electrical apparatuses and flexible printed wiring boards, and the like have been demanded to have higher heat resistance and also high elongation and high strength, i.e., higher toughness, in recent years.

For example, in high-output motors, in order to achieve size reduction and increase in efficiency (increase in output) with a high space factor, the following processing operations are employed: a coil is subjected to press processing, the number of insulated wires inserted into a slot of a stator core of a motor is increased, or insulated wires forming coils are formed so as to have the cross-sectional shapes of a hexagon, rectangle, etc., from a circular shape. In the above-mentioned processing operations, insulating materials having excellent toughness are demanded so as to prevent fracture or the like of an insulating coating film and the like occurring in connection with the processing operations. Moreover, heat-resistant resin films for use in driving units of cellular phones, printers, etc., are demanded to have mechanical properties, such as excellent toughness allowing resisting driving, such as bending, together with high heat resistance.

As an insulating material having excellent toughness together with high heat resistance, polyimide resin is known. By the use of polyimide resin, higher heat resistance and more excellent toughness can be achieved. However, polyimide resin is expensive and has problems in terms of processability. Therefore, a high-toughness heat-resistant resin material which is inexpensive and which has excellent processability has been demanded.

As a heat-resistant resin material which is less expensive and has better processability, higher heat resistance, and higher toughness than polyimide resin, a mixture of polyamide-imide resin and polyimide resin has been proposed and is, for example, described in Japanese Unexamined Patent Application Publication No. 2005-78934 (Patent Document 1), Japanese Unexamined Patent Application Publication No. 2005-302597 (Patent Document 2), etc.

[Patent Document 1] Japanese Unexamined Patent Application Publication No. 2005-78934

[Patent Document 2] Japanese Unexamined Patent Application Publication No. 2005-302597

### DISCLOSURE OF INVENTION

### Problems to be Solved by the Invention

However, as described in Paragraph 0010 of Patent Document 1, “In general, it is difficult to simply mix polyamide-imide varnish and polyamide acid (precursor of polyimide resin) varnish. However, the mixture is stabilized by heating from 60 to 80° C. while mixing, and then cooling to room temperature.”, when polyamide-imide resin and polyamide acid are ordinarily mixed, the viscosity increases (gelling), causing a problem with difficulty of application. In order to prevent the problem, it is necessary to provide, after heating and mixing, a complicated process of cooling for stabilization. Even when such a process is provided, the mixing becomes difficult in practice in many cases.

The present invention has been made in view of the above-described problems. The present invention aims to provide a heat-resistant resin varnish whose viscosity does not increase even when complicated processes, such as heating and cooling, are not provided; which is easily applied to a substrate, such as a wire; which can form a cured product having excellent strength and elongation (toughness) which are comparable to those obtained in a case where polyimide resin is used; and which is inexpensive compared with a polyimide resin varnish.

The present invention also provides a heat-resistant resin film containing a cured product of the heat-resistant resin varnish and having excellent toughness and a heat-resistant resin composite containing the heat-resistant resin film as a component.

The present invention also provides an insulated wire which is covered with an insulating coating film which has high heat resistance and excellent toughness comparable to those of polyimide resin and which is easily produced.

### Means for Solving the Problems

The present inventors have conducted extensive research. As a result, the present inventors found that, by mixing polyamide-imide resin and polyamide acid after blocking the terminal isocyanate functional group of the polyamide-imide resin with a blocking agent, increase in viscosity (gelling) occurring in connection with the mixing can be suppressed and a mixture having low viscosity which allows application can be obtained without heating, cooling, etc. The present inventors further found that a cured product obtained by baking the mixture thus obtained has excellent toughness close to or comparable to that of polyimide resin. Thus, the present invention has been accomplished.

More specifically, the present invention provides a heat-resistant resin varnish containing polyamide-imide resin whose terminal isocyanate functional group has been blocked with a blocking agent and polyamide acid (claim 1).

The polyamide-imide resin usable here can be produced by, for example, a method of directly reacting tricarboxylic acid anhydride with polyvalent isocyanates having two or more isocyanate groups in a single molecule in an organic solvent or a method of first reacting tricarboxylic acid anhydride with polyvalent amines having two or more amine groups in a single molecule in a polar solvent to introduce imide bond in the first place, and then amidating with polyvalent isocianates having two or more isocyanate groups in a single molecule.

Examples of tricarboxylic anhydride include at least one member selected from trimellitic anhydride (TMA), 2-(3,4-dicarboxyphenyl)-2-(3-carboxyphenyl) propane anhydride, (3,4-dicarboxyphenyl) (3-carboxyphenyl) methane anhydride, (3,4-dicarboxyphenyl) (3-carboxyphenyl)ether anhydride, 3,3′,4-tricarboxy benzophenone anhydride, 1,2,4-butane tricarboxylic anhydride, 2,3,5-naphthalene tricarboxylic acid anhydride, 2,3,6-naphthalene tricarboxylic acid anhydride, 1,2,4-naphthalene tricarboxylic acid anhydride, 2,2′,3-biphenyl tricarboxylic acid anhydride, etc. It is preferable to use TMA from the viewpoint of heat resistance and cost.

As required, polybasic acids other than the above-mentioned tricarboxylic anhydrides or functional derivative thereof can be used together. Examples of polybasic acids include at least one member selected from tribasic acids, such as trimesic acid and tris(2-carboxyethyl) isocyanurate; dibasic acids, such as terephthalic acid, isophthalic acid, succinic acid, adipic acid, sebacic acid, and dodecanedicarboxylic acid; aliphatic or alicyclic tetrabasic acids, such as 1,2,3,4-butane tetracarboxylic acid, cyclopentanetetracarboxylic acid, and ethylenetetracarboxylic acid; aromatic tetrabasic acids, such as pyromellitic acid, 3,3′,4,4′-benzophenonetetracarboxylic acid, bis(3,4-dicarboxyphenyl)ether, 2,3,6,7-naphthalenetetracarboxylic acid, 1,2,5,6-naphthalenetetracarboxylic acid, 2,2′-bis(3,4-dicarboxyphenyl) propane, 2,2′,3,3′-diphenyltetracarboxylic acid, bis(3,4-dicarboxyphenyl) sulfone, and bis(3,4-dicarboxyphenyl) methane.

Examples of polyvalent isocyanates having two or more isocyanate groups in a single molecule include aliphatic, alicyclic, aromatic/aliphatic, aromatic, and heterocyclic polyisocyanates. More specific examples include at least one member selected from ethylene diisocyanate 1,4-tetramethylene diisocyanate, 1,6-hexamethylene diisocyanate, 1,12-dodecanediisocyanate, cyclobutene-1,3-diisocyanate, cyclohexane-1,3-diisocyanate, cyclohexane-1,4-diisocyanate, isophorone diisocyanate, 1,3-phenylene diisocyanate, 1,4-phenylene diisocyanate, 2,4-tolylene diisocyanate, 2,6-tolylene diisocyanate, diphenylmethane-2,4′-diisocyanate, diphenylmethane-4,4′-diisocyanate (MDI), diphenylether-4,4′,-diisocyanate, xylylene diisocyanate, naphthalene-1,5-diisocyanate, 1-methoxybenzene-2,4-diisocyanate, 1-methoxybenzene-2,4-diisocyanate, diphenylsulfone-4,4′-diisocyanate, and compounds having three or more isocyanate groups in a single molecule obtained by quantifying the above-mentioned diisocyanates, polyphenyl methylene polyisocyanate, etc.

Reaction of tricarboxylic anhydrides or functional derivative thereof, polybasic acids used together as required or functional derivatives thereof, and polyvalent isocyanates having two or more isocyanate groups in a single molecule is preferably performed in an organic solvent. Examples of the organic solvent include N-methyl-2-pyrolidone (NM2P), N,N′-dimethylformamide, N,N-dimethylacetamide, and dimethylsulfoxide. It is preferable to use NM2P as a synthetic solvent from the viewpoint of reactivity or performance of resin to be synthesized.

The polyamide-imide resin can be produced by, for example, subjecting TMA and MDI to an equimolar reaction in an NM2P solvent. It is preferable for the polyamide-imide resin to have a number average molecular weight (hereinafter sometimes referred to as a molecular weight) of 10,000 or more. When the molecular weight is lower than 10,000, entanglement of polyamide-imide molecular chains or entanglement of a polyamide-imide molecular chain and a polyimide molecular chain becomes insufficient. This results in a tendency that the toughness of a heat-resistant resin film which is obtained by baking a heat-resistant resin varnish or an insulating coating film of an insulated wire decreases. Claim 2 corresponds to this preferable aspect. As the polyamide-imide resin, a commercially-available polyamide-imide resin varnish (e.g., Tradename: AE2 or the like, manufactured by Taoka Chemical Co., Ltd.) can be used. It should be noted that, here, the number average molecular weight is a value measured by GPC in terms of polystyrene. The same applies hereinafter.

Polyamide acid can be produced by, for example, reacting tetracarboxylic acid dianhydride and diamine at a low temperature in a polar solvent.

Examples of tetracarboxylic acid dianhydride usable here include at least one member selected from 3,3′,4,4′-biphenyl tetracarboxylic acid dianhydride (BPDA), 3,3′,4,4′-benzophenone tetracarboxylic acid dianhydride (BTDA), 3,3′,4,4′-biphenyl ether tetracarboxylic acid dianhydride (OPDA), 3,3′,4,4′-diphenylsulfone tetracarboxylic acid dianhydride (DSDA), bicyclo(2,2,2)-oct-7-ene-2,3,5,6-tetracarboxylic acid dianhydride (BCD), 1,2,4,5-cyclohexanetetracarboxylic acid dianhydride (H-PMDA), pyromellitic acid dianhydride (PMDA), 2,2-bis(3,4-dicarboxyphenyl) hexafluoro propane dianhydride (6FDA), and 5-(2,5-dioxotetrahydrofuryl)-3-methyl-3-cyclohexene-1,2-dicarboxylic acid anhydride (CP).

Examples of diamine usable here include at least one member selected from p-phenylenediamine, m-phenylenediamine, silicone diamine, bis(3-aminopropyl)ether ethane, 3,3′-diamino-4,4′dihydroxydiphenylsulfone (SO₂-HOAB), 4,4′diamino-3,3′ dihydroxy biphenyl (HOAB), 2,2-bis[4-(4-aminophenoxy)phenyl] hexafluoro propane (HOCF₃AB), siloxane diamine, bis(3-aminopropyl)ether ethane, N,N-bis(3-aminopropyl)ether, 1,4-bis(3-aminopropyl) piperazine, isophoronediamine, 1,3′-bis(aminomethyl) cyclohexane, 3,3′-dimethyl-4,4′-diaminodicyclohexylmethane, 4,4′-methylene bis(cyclohexylamine), 4,4′-diaminodiphenyl ether (DDE), 3,4′-diaminodiphenyl ether (m-DDE), 3,3′-diaminodiphenyl ether, 4,4′-diamino diphenylsulfone (p-DDS), 3,4′-diamino-diphenylsulfone, 3,3′-diamino-diphenylsulfone, 2,4′-diaminodiphenyl ether, 1,3-bis(4-aminophenoxy) benzene (m-TPE),1,3-bis(3-aminophenoxy) benzene (APB), 2,2-bis[(4-(4-aminophenoxy)phenyl)] propane (BAPP), 2,2-bis[(4-(4-aminophenoxy)phenyl)] hexafluoropropane (HF-BAPP), bis[4-(4-aminophenoxy)phenyl]sulfone (p-BAPS), bis[4-(3-aminophenoxy) phenyl] sulfone (m-BAPS), 4,4bis(4-aminophenoxy)biphenyl (BAPB), 1,4-bis(4-aminophenoxy)benzene (p-TPE), 4,4′-diamino diphenyl sulfide (ASD), 3,4′-diamino diphenyl sulfide, 3′3′-diamino diphenyl sulfide, 3,3′diamino-4,4′ dihydroxydiphenylsulfone, 2,4-diaminotoluene (DAT), 2,5-diaminotoluene, 3,5-diaminobenzoic acid (DABz), 2,6-diaminopyridine (DAPy), 4,4′diamino-3,3′ dimethoxybiphenyl (CH₃OAB), 4,4′diamino-3,3′dimethylbiphenyl (CH₃AB), 9,9′-bis(4-aminophenyl) fluorene (FDA), etc.

It is preferable to react tetracarboxylic acid dianhydride and diamine in an organic solvent. Examples of the organic solvent include NM2P, N,N′-dimethylformamide, N,N-dimethylacetamide, and dimethyl sulfoxide. It is preferable to use NM2P from the viewpoint of reactivity or performange of a resin to be synthesized.

In general, polyimide resin produced by equimolar reaction of PMDA and DDE in NM2P is the most inexpensive and user-friendly, and thus is widely used. Polyamide acid having a number average molecular weight of 30,000 or more is preferable. As such polyamide acid, it is also possible to use commercially-available polyamide acid varnish (e.g., Tradename: Pyre ML and the like, manufactured by I.S.T.).

To the heat-resistant resin varnish of the present invention, other compounding agents may be added as required. As an example thereof, lubricants, such as polyethylene; adherence improvers, such as a coupling agent; metal and a semiconductor, and oxides, nitrides, carbides thereof; fillers, such as carbon black, etc., are mentioned.

The present invention has a feature such that polyamide-imide resin whose terminal isocyanate functional group has been processed and blocked with a blocking agent is used. When polyamide acid (a polyimide resin varnish or the like) and polyamide-imide resin are simply mixed without blocking, a mixture is thickened. In particular, when the amount of polyamide acid reaches 20% by weight or more based on the total resin amount (total of polyamide acid and polyamide-imide resin), the viscosity of the mixture remarkably increases, resulting in difficulty of covering application. In contrast, the blocking treatment is performed, reaction of a polyimide resin varnish (polyamide acid) and polyamide-imide resin is suppressed, and thus increase in viscosity due to the mixing can be prevented.

Blocking the terminal isocyanate functional group of polyamide-imide resin with a blocking agent has been proposed also in Japanese Unexamined Patent Application Publication No. 6-65540. However, Japanese Unexamined Patent Application Publication No. 6-65540 proposes the blocking treatment as a measure to improve the lubricity of the surface of an insulated wire and the blocking target is a polymer having a polysiloxane functional group. This is different from the means for solving the problems of the present invention.

As a blocking agent, alcohols and phenols can be mentioned. Examples of alcohols include methanol, ethanol, propanol, butanol, methyl cellosolve, ethyl cellosolve, methyl carbitol, benzyl alcohol, and cyclohexanol. Examples of phenols include phenol, cresol, and xylenol. From the viewpoint of physical properties of a cured product after varnish baking, e.g., mechanical properties, such as toughness, alcohols are preferable.

When polyamide-imide resin and a blocking agent of given amounts are stirred at about 70° C. for about 2 hours, for example, polyamide-imide resin whose terminal isocyanate functional group has been blocked with a blocking agent can be obtained.

The heat-resistant resin varnish of the present invention can be obtained by mixing the polyamide-imide resin whose terminal isocyanate functional group has been blocked with a blocking agent obtained described above and polyamide acid. The mixing method is not limited, and the mixing can be performed in a routine manner. As described above, increase in viscosity due to mixing is suppressed. Moreover, the heat-resistant resin varnish of the present invention provides a cured product having excellent toughness. When the compounding ratio of polyamide acid is 50% by weight or more, the obtained cured product exhibits toughness equivalent to that of a cured product obtained from an expensive polyimide resin varnish. Also when the compounding ratio of polyamide acid is lower than 50% by weight, the cured product obtained from the heat-resistant resin varnish of the present invention exhibits favorable toughness which far exceeds an expected value of toughness obtained by proportionally dividing the toughness of a cured product obtained from a polyimide resin varnish and the toughness of a cured product obtained from a varnish of only polyamide-imide resin based on the compounding ratio.

With respect to the compounding ratio of the polyamide-imide resin whose terminal isocyanate functional group has been blocked with a blocking agent to polyamide acid, the content of polyamide acid is preferably 5 to 50% by weight relative to the total content thereof (claim 3).

When the compounding ratio of polyamide acid is lower than 5% by weight, there is tendency that the toughness of the obtained cured product of the heat-resistant resin varnish becomes insufficient. In contrast, even when the compounding ratio becomes larger than 50% by weight, further improvement in toughness is not recognized, and a material cost increases thereagainst.

It is preferable that the viscosity of the heat-resistant resin varnish of the present invention containing polyamide-imide resin and polyamide acid be 200,000 mPa·s or lower (30° C., B-type viscometer) (claim 4). When the viscosity exceeds 200,000 mPa·s, uniform covering application to a substrate becomes difficult. Or, solvent dilution is required for realization of uniform application, resulting in increased cost. Moreover, since a solvent, such as NM2P, has high moisture absorption, hydrolysis of a polyimide precursor is likely to occur, resulting in that the stability of a varnish decreases. In addition, since the solid content of a varnish decreases due to solvent dilution, it becomes difficult to obtain a thick film. Thus, such a viscosity is not preferable. More preferable viscosity is within the range of from 1,000 to 100,000 mPa·s.

In particular, when the heat-resistant resin varnish is used for forming an insulating coating film of an insulated wire, the viscosity thereof is preferably 10,000 mPa·s or lower. When the viscosity exceeds 10,000 mPa·s, uniform covering application to a wire sometimes become difficult. When the heat-resistant resin varnish is used for forming an insulating coating film, a still more preferable viscosity is within the range of from 1,000 to 7,000 mPa·s.

In addition to the heat-resistant resin varnish, the present invention provides a heat-resistant resin film containing a cured product in which the heat-resistant resin varnish has been baked and is in the form of a film or tube (claim 5).

The baking treatment of a heat-resistant resin varnish is performed by, for example, applying the heat-resistant resin varnish to a substrate to form a coating film on the substrate, and then heating the coating film to cure the heat-resistant resin varnish. A cured product is obtained by the baking treatment. During the process, polyamide acid is thermally imidized to form an imide ring. Thus, the baking treatment temperature is a temperature higher than a temperature required for the formation of an imide ring. The application and baking of the heat-resistant resin varnish to a substrate can be performed in a routine manner. The application and baking of the heat-resistant resin varnish may be repeated by twice or more.

Examples of the substrate used here include metal substrates, such as a metal bar, a metal wire, and a metal plate, a plastic sheet, a plastic bar, and a glass plate. When the heat-resistant resin film of the present invention is formed on a substrate, the heat-resistant resin film can be separated from the substrate for use. In contrast, the heat-resistant resin film can be used while being joined to and integrated with the substrate or the heat-resistant resin film can be integrated with another substrate after separation. In the above cases, a heat-resistant resin composite having a substrate and a heat-resistant resin film is obtained. The present invention also provides such a heat-resistant resin composite (claim 6).

The form of the heat-resistant resin film of the present invention is not limited to a film (plate-shaped), and a tube-shaped (tubular) film is also mentioned as the heat-resistant resin film of the present invention. For example, a heat-resistant resin film formed by applying the heat-resistant resin varnish of the present invention to a metal bar, a metal wire, a plastic bar, etc., has a tubular shape.

The cured product obtained by the heat-resistant resin varnish is excellent in heat resistance and also has excellent strength and elongation, i.e., toughness. Thus, the heat-resistant resin film of the present invention containing a cured product obtained from the heat-resistant resin varnish is also excellent in heat resistance and also has high strength and elongation, i.e., excellent toughness; shows excellent mechanical properties in which breakage or the like by driving is suppressed; and is preferably used for driving units, insulating coating films, etc., of various electrical apparatuses.

The present invention further provides an insulated wire having an insulating coating film formed using the above-described heat-resistant resin varnish.

More specifically, the insulated wire of the present invention is an insulated wire having a wire and an insulating coating film covering the surface of the wire.

The insulating coating film has a feature of containing at least one insulating layer formed by applying the heat-resistant resin varnish according to any one of claims 1 to 4 to the wire directly or through an insulating layer containing another insulating covering material, and baking the resultant (claim 7).

The insulated wire of the present invention is obtained by applying the heat-resistant resin varnish (insulating covering material) to the wire, and baking the resultant. The baking treatment can be performed under the same conditions as in the case where the above-described heat-resistant resin film is produced.

As the wire, a copper wire containing pure copper or copper alloy is mentioned. A wire containing another metal material, such as a silver wire, and various metal plated wires, such as a tin plated wire, are also mentioned as the wire. Examples of the cross sectional shape of the wire include a circular wire, a rectangular wire, a hexagonal wire, and the cross sectional shape thereof is not limited. In order to increase the space factor, a hexagonal wire whose cross sectional shape is hexagonal and a rectangular wire whose cross sectional shape is rectangular are preferable (claim 8).

The above-described heat-resistant resin varnish may be directly applied to the wire. In the case where the insulating coating film contains a plurality of insulating layers, the above-described heat-resistant resin varnish may be applied to another insulating layer formed on the wire, i.e., an insulating layer formed of an insulating material other than the above-described heat-resistant resin varnish. Moreover, an insulating layer formed of another insulating material can be provided on the insulating layer formed of the above-described heat-resistant resin varnish. After the application, baking is performed to cure the heat-resistant resin varnish, whereby an insulating layer is formed.

The insulating coating film of the insulated wire thus obtained is excellent in heat resistance and has high strength and high elongation, i.e., excellent toughness. A wire having the insulating coating film is prevented from breakage or the like of the coating film during processing of the wire, and thus is preferable. Excellent effects are exhibited when the cross section is processed into the shape of a hexagon or a rectangle, a coil is subjected to press processing, or the number of the insulated wires inserted into a slot of a stator core is increased.

### ADVANTAGES

The heat-resistant resin varnish of the present invention is low in price, and a cured product obtained by subjecting the varnish to high temperature imidization has strength and elongation comparable to polyimide resin, i.e., excellent toughness. Moreover, the heat-resistant resin varnish is easy to apply (form a heat-resistant resin film) because the varnish is free from a problem with increase in viscosity.

Since the heat-resistant resin film of the present invention has excellent strength and excellent elongation, i.e., high toughness, breakage or the like due to driving is suppressed. Thus, the heat-resistant resin film is preferably used for driving units, insulating coating films, etc., of various electrical apparatuses by itself in addition to as a component of the heat-resistant resin composite of the present invention.

Since the insulated wire of the present invention has an insulating coating film excellent in heat resistance and toughness, breakage or the like of the insulating coating film is difficult to occur during processing of an insulated wire, e.g., the cross sectional shape is formed into the shape of a hexagon or a rectangle, a coil is subjected to press processing, or the number of insulated wires inserted into a slot of a stator core is increased.

### BRIEF DESCRIPTION OF DRAWINGS

FIG. 1 is a graph illustrating the relationship between the compounding ratio of polyamide acid and tensile strength in Examples 1 to 6 and Comparative Examples 1 and 2.

FIG. 2 is a graph illustrating the relationship between the compounding ratio of polyamide acid and fracture elongation in Examples 1 to 6 and Comparative Examples 1 and 2.

FIG. 3 is a graph illustrating the relationship between the compounding ratio of polyamide acid and tensile strength in Examples 7 to 12 and Comparative Examples 2 and 3.

FIG. 4 is a graph illustrating the relationship between the compounding ratio of polyamide acid and fracture elongation in Examples 7 to 12 and Comparative Examples 2 and 3.

FIG. 5 is a schematic view illustrating a sea-island structure of a resin composite obtained by the present invention.

### BEST MODES FOR CARRYING OUT THE INVENTION

Hereinafter, best modes for carrying out the present invention will be described with reference to the following Examples, but the scope of the present invention is not limited to only the following Examples.

### EXAMPLES

### Examples 1 to 6

### Production of a Heat-Resistant Resin Varnish

To 600 g of polyamide-imide resin varnish having a molecular weight of 16,500, a solid content of 27%, and a viscosity of 3,600 mPa·s (Tradename: AE2, manufactured by Taoka Chemical Co., Ltd.), 3 g of Methanol was added as a blocking agent. The mixture was reacted at 70° C. for 2 hours to obtain 603 g of polyamide-imide resin whose terminal isocyanate functional group was blocked.

It should be noted that the molecular weight of resin of the resin varnish was obtained by GPC (HLC-8220GPC, manufactured by TOSOH Corporation) using a 1% by weight solution in which the resin varnish was diluted with NM2P. As a carrier solvent, a substance in which LiBr was dissolved in NM2P was used.

The thus-obtained polyamide-imide resin whose terminal isocyanate functional group was blocked and a polyimide resin varnish having a molecular weight of 35,000 and a viscosity of 4,200 mPa·s (varnish of polyamide acid manufactured by I.S.T., Tradename: Pyre m.l.) were mixed at 25° C. for 2 hours while adjusting a compounding ratio in such a manner that the weight ratio of polyamide-imide resin after baking to polyimide resin (formed by cyclization of polyamide acid) was equivalent to a ratio of the corresponding numerical values indicated in the rows of PAI and PI (PAI:PI) of Table I. Thus, 6 types of heat-resistant resin varnishes which were different in the compounding ratio of polyamide-imide resin to polyamide acid were obtained.

### (Measurement of the Viscosity of a Heat-Resistant Resin Varnish)

(1) In the case where the compounding ratio of polyamide-imide resin to polyamide acid (weight ratio) was 50:50 (compounding ratio of Example 6), the viscosity of the heat-resistant resin varnish after mixing was measured using a B-type viscometer (Rotor No. 3, number of rotations of 12 rpm) to be 6,210 mPa·s (Measurement temperature: 30° C.). The viscosity was lower than the viscosity allowing application (200,000 mPa·s), and thus the application was sufficiently performed at the viscosity.

(2) In contrast, the same polyamide-imide resin varnish and the same polyimide resin varnish as the above were used, and similarly mixed at a weight ratio of 50:50, except that the terminal isocyanate functional group was not blocked. The viscosity was measured to be 533,000 mPa·s and far exceeded the viscosity allowing application (200,000 mPa·s). It should be noted that even when the viscosity of the varnish is 200,000 mPa·s or more, application becomes possible by diluting with a solvent. However, since an expensive solvent is used, the cost is increased. Further, since a diluting solvent, such as NM2P, has high moisture absorption, hydrolysis of a polyimide precursor is likely to occur, resulting in reduced stability of the varnish. In addition thereto, the solid content of the varnish decreases with solvent dilution. Therefore, it becomes difficult to obtain a thick film, and thus the use of a film is limited.

(3) In the case where the compounding ratio of polyamide-imide resin to polyamide acid (weight ratio) was 70:30 (compounding ratio of Example 4), the viscosity of an insulating covering material after mixing was measured using a B-type viscometer (Rotor No. 3, number of rotations of 12 rpm) to be 5,000 mPa·s (Measurement temperature: 30° C.). The viscosity was lower than the upper limit of the viscosity range (10,000 mPa·s) preferable for forming an insulating coating film of an insulated wire, and was preferable for application.

(4) In contrast, the same polyamide-imide resin varnish and the same polyimide resin varnish as the above were used, and similarly mixed in a weight ratio of 70:30, except that the terminal isocyanate functional group was not blocked. The viscosity was measured to be 23,000 mPa·s and far exceeded the upper limit of the viscosity range (10,000 mPa·s) preferable for forming an insulating coating film.

### (Production of a Heat-Resistant Resin Film)

The 6 types of heat-resistant resin varnishes were applied to the outer circumference of a metal wire (copper wire) having a diameter of about 1.0 mm, and baked using a baking furnace to obtain heat-resistant resin composites (insulated wires) each having a heat-resistant resin film (insulated coating film) with a thickness of 32 to 34 μm on the surface.

### (Flexibility Evaluation)

To the obtained heat-resistant resin composites (insulated wires), preliminary tensions of 0, 10, 20, and 30% were applied, and then a flexibility test was performed according to a method based on JIS C-3003. Evaluation was performed by winding 30 turns of wire around a 1.0 mm circular bar, and counting the number of turns in which fracture of a film (coating film) occurred. Then, the evaluation results were indicated as n/30 (fracture occurring in n turns among 30 turns). The results are shown in Table I.

The metal wires (copper wires) were removed from the obtained heat-resistant resin composites (insulated wires) to obtain tubular films with a thickness of 32 to 34 μm (heat-resistant resin films, insulating coating films).

### (Evaluation of Physical Properties of the Heat-Resistant Resin Films)

Using the obtained tubular films, measurement and evaluation were performed with respect to the items shown in Table I and according to the method described below. The results are also shown in Table I.

1. Tensile strength and Fracture elongation: Each tubular film was set in a tensile tester (AG-IS, manufactured by Shimadzu Corporation), while the distance between chucks being set to 20 mm, and pulled at a rate of 10 mm/minute. Then, the strength and elongation when the film was broken were measured.

2. Heat resistance: Measurement was performed using a dynamic mechanical analyzer (DMS6100, manufactured by Seiko Instruments) in a nitrogen atmosphere and at a temperature increase rate of 10° C./minute. Then, the softening temperature (extrapolation temperature at which the dynamic storage modulus decreases) of each tubular film resin was evaluated.

### Examples 7 to 12

To 600 g of polyamide-imide resin varnish (Molecular weight of 22,000, Solid content of 23%, Viscosity of 4,300 mPa·s) obtained by reacting TMA and MDI in NM2P, 3 g of methanol was added as a blocking agent. The mixture was reacted at 70° C. for 2 hours to obtain 603 g of polyamide-imide resin whose terminal isocyanate functional group was blocked. Tubular films (heat-resistant resin films, insulating coating films) were produced in the same manner as in Examples 1 to 6, except using the polyamide-imide resin whose terminal isocyanate functional group was blocked, and then measured and evaluated for the same items. The results are shown in Table II.

### Examples 13 to 18

To 600 g of polyamide-imide resin varnish (Molecular weight of 5,500, Solid content of 30%) obtained by reacting TMA and MDI in NM2P, 3 g of methanol was added as a blocking agent. The mixture was reacted at 70° C. for 2 hours to obtain 603 g of polyamide-imide resin whose terminal isocyanate functional group was blocked. Tubular films (heat-resistant resin films, insulating coating films) were produced in the same manner as in Examples 1 to 6, except using the polyamide-imide resin whose terminal isocyanate functional group was blocked, and then measured and evaluated for the same items. The results are shown in Table III.

### Comparative Examples 1 and 2

Tubular films (heat-resistant resin films, insulating films) were produced in the same manner as in Examples 1 to 6 using only either one of the same polyamide-imide resin (Comparative Example 1) or the same polyimide resin varnish (Comparative Example 2) as that used in Examples 1 to 6, and were measured and evaluated for the same items. The obtained tubular films are referred to as Comparative Examples 1 and 2 and the measurement and evaluation results thereof are also shown in Table I.

### Comparative Example 3

A tubular film (heat-resistant resin film, insulating film) was produced in the same manner as in Examples 1 to 6 using the same polyamide-imide resin as that used in Examples 7 to 12 with using no polyimide resin varnish, and was measured and evaluated for the same items. The obtained tubular film is referred to as Comparative Example 3 and the evaluation and measurement results thereof are also shown in Table II.

### Comparative Example 4

Tubular films (heat-resistant resin films, insulating films) were produced in the same manner as in Examples 1 to 6 using the same polyamide-imide resin as that used in Examples 13 to 18 with using no polyimide resin varnish, and were measured and evaluated for the same items. The measurement and evaluation results are also shown in Table III.

TABLE I

| | | | | | | | | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 1 | Ex. 2 |
| PAI | | 95 | 90 | 80 | 70 | 60 | 50 | 100 | — |
| PI | | 5 | 10 | 20 | 30 | 40 | 50 | — | 100 |
| Metal wire | | 1.015 | 1.015 | 1.015 | 1.014 | 1.014 | 1.012 | 1.016 | 1.015 |
| diameter (mm) | | | | | | | | | |
| Finished outer | | 1.079 | 1.079 | 1.083 | 1.082 | 1.081 | 1.076 | 1.082 | 1.077 |
| diameter (mm) | | | | | | | | | |
| Heat-resistance | | 32.0 | 32.0 | 34.0 | 34.0 | 33.5 | 32.0 | 33.0 | 31.0 |
| film thickness | | | | | | | | | |
| (μm) | | | | | | | | | |
| Flexibility | 0% | 0/30 | 0/30 | 0/30 | 0/30 | 0/30 | 0/30 | 0/30 | 0/30 |
| (n/30) | elongation | | | | | | | | |
| | 10% | 0/30 | 0/30 | 0/30 | 0/30 | 0/30 | 0/30 | 0/30 | 0/30 |
| | elongation | | | | | | | | |
| | 20% | 0/30 | 0/30 | 0/30 | 0/30 | 0/30 | 0/30 | 4/30 | 0/30 |
| | elongation | | | | | | | | |
| | 30% | 0/30 | 0/30 | 0/30 | 0/30 | 0/30 | 0/30 | 12/30 | 0/30 |
| | elongation | | | | | | | | |

(Film physical properties)

| | | | | | | | | |
|---|---|---|---|---|---|---|---|---|
| Tensile strength | 149 | 150 | 165 | 180 | 175 | 190 | 140 | 190 |
| (MPa) | | | | | | | | |
| Fracture | 75 | 76 | 80 | 93 | 100 | 110 | 57 | 115 |
| elongation (%) | | | | | | | | |
| Heat resistance | 292 | 291 | 291 | 292 | 292 | 293 | 286 | 343 |
| (° C.) | | | | | | | | |

TABLE II

| | | | | | | | | Comp. | Comp. |
|---|---|---|---|---|---|---|---|---|---|
| | | Ex. 7 | Ex. 8 | Ex. 9 | Ex. 10 | Ex. 11 | Ex. 12 | Ex. 2 | Ex. 3 |
| PAI | | 95 | 90 | 80 | 70 | 60 | 50 | — | 100 |
| PI | | 5 | 10 | 20 | 30 | 40 | 50 | 100 | — |
| Metal wire | | 1.017 | 1.016 | 1.016 | 1.016 | 1.014 | 1.014 | 1.015 | 1.015 |
| diameter (mm) | | | | | | | | | |
| Finished outer | | 1.083 | 1.08 | 1.081 | 1.084 | 1.078 | 1.078 | 1.077 | 1.078 |
| diameter (mm) | | | | | | | | | |
| Heat-resistance | | 33.0 | 32.0 | 32.5 | 34.0 | 32.0 | 32.0 | 31.0 | 31.5 |
| film thickness | | | | | | | | | |
| (μm) | | | | | | | | | |
| Flexibility | 0% | 0/30 | 0/30 | 0/30 | 0/30 | 0/30 | 0/30 | 0/30 | 0/30 |
| (n/30) | elongation | | | | | | | | |
| | 10% | 0/30 | 0/30 | 0/30 | 0/30 | 0/30 | 0/30 | 0/30 | 0/30 |
| | elongation | | | | | | | | |
| | 20% | 0/30 | 0/30 | 0/30 | 0/30 | 0/30 | 0/30 | 0/30 | 2/30 |
| | elongation | | | | | | | | |
| | 30% | 0/30 | 0/30 | 0/30 | 0/30 | 0/30 | 0/30 | 0/30 | 4/30 |
| | elongation | | | | | | | | |

(Film physical properties)

| | | | | | | | | |
|---|---|---|---|---|---|---|---|---|
| Tensile strength | 140 | 150 | 170 | 172 | 174 | 176 | 190 | 137 |
| (MPa) | | | | | | | | |
| Fracture | 70 | 78 | 100 | 105 | 107 | 110 | 115 | 60 |
| elongation (%) | | | | | | | | |
| Heat resistance | 289 | 288 | 290 | 289 | 288 | 290 | 343 | 280 |
| (° C.) | | | | | | | | |

TABLE III

| | | | | | | | | Comp. | Comp. |
|---|---|---|---|---|---|---|---|---|---|
| | | Ex. 13 | Ex. 14 | Ex. 15 | Ex. 16 | Ex. 17 | Ex. 18 | Ex. 2 | Ex. 4 |
| PAI | | 95 | 90 | 80 | 70 | 60 | 50 | — | 100 |
| PI | | 5 | 10 | 20 | 30 | 40 | 50 | 100 | — |
| Metal wire | | 1.022 | 1.023 | 1.020 | 1.020 | 1.022 | 1.015 | 1.015 | 1.022 |
| diameter (mm) | | | | | | | | | |
| Finished outer | | 1.090 | 1.088 | 1.086 | 1.086 | 1.087 | 1.077 | 1.077 | 1.088 |
| diameter (mm) | | | | | | | | | |
| Heat-resistance | | 34.0 | 32.5 | 33.0 | 33.0 | 32.5 | 31.0 | 31.0 | 33.0 |
| film thickness | | | | | | | | | |
| (μm) | | | | | | | | | |
| Flexibility | 0% | 0/30 | 0/30 | 0/30 | 0/30 | 0/30 | 0/30 | 0/30 | 0/30 |
| (n/30) | elongation | | | | | | | | |
| | 10% | 0/30 | 0/30 | 0/30 | 0/30 | 0/30 | 0/30 | 0/30 | 0/30 |
| | elongation | | | | | | | | |
| | 20% | 6/30 | 4/30 | 3/30 | 2/30 | 1/30 | 0/30 | 0/30 | 5/30 |
| | elongation | | | | | | | | |
| | 30% | 16/30 | 14/30 | 4/30 | 2/30 | 1/30 | 1/30 | 0/30 | 20/30 |
| | elongation | | | | | | | | |

(Film physical properties)

| | | | | | | | | |
|---|---|---|---|---|---|---|---|---|
| Tensile strength | 140 | 149 | 155 | 154 | 165 | 170 | 190 | 132 |
| (MPa) | | | | | | | | |
| Fracture | 45 | 50 | 55 | 57 | 59 | 66 | 115 | 38 |
| elongation (%) | | | | | | | | |
| Heat resistance | 302 | 289 | 298 | 300 | 299 | 294 | 343 | 303 |
| (° C.) | | | | | | | | |

It should be noted that, in Table I, II, and III, PAI represents polyamide-imide resin and PI illustrates polyimide resin.

Tables I and II show the results when polyamide-imide resin having a molecular weight of 10,000 or more was used (Examples and Comparative Examples). As is clear from Tables I and II, the heat-resistant resin film (insulating coating film) obtained in each Example is excellent in heat resistance and flexibility as compared with the heat-resistant resin films (insulating coating films) obtained using only polyamide-imide resin of Comparative Examples 1 and 3. Moreover, tensile strength and/or fracture elongation are/is excellent, and toughness is also excellent.

Table 3 shows the results of Examples (and Comparative Examples) when polyamide-imide resin having a molecular weight lower than 10,000 was used. As is clear from the comparison between the results of Table III and the results shown in Tables I and II, when polyamide-imide resin having a molecular weight lower than 10,000 was used, toughness, especially fracture elongation, is low as compared with the case where polyamide-imide resin having a molecular weight of 10,000 or more was used. This shows that the molecular weight of polyamide-imide resin is preferably 10,000 or more.

However, even in the case where polyamide-imide resin having a molecular weight lower than 10,000 was used, the heat-resistant resin film (insulating coating film) obtained in each Example is excellent in tensile strength and/or fracture elongation, and thus is excellent in toughness, as compared with the heat-resistant resin film (insulating coating film) obtained using only polyamide-imide resin of Comparative Example 4. Moreover, also in flexibility, the heat-resistant resin film obtained in each Example is more excellent as compared to the case where only polyamide-imide resin was used, especially when the proportion of polyamide acid (polyimide resin varnish) exceeds 20% by weight.

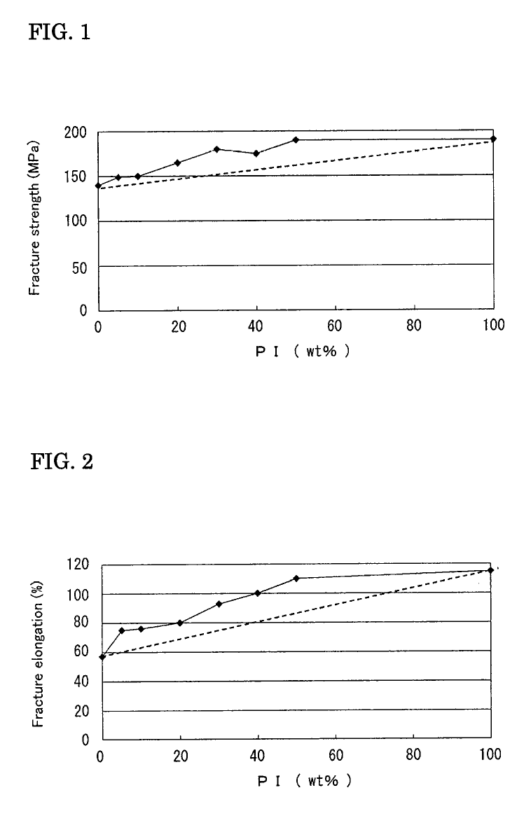

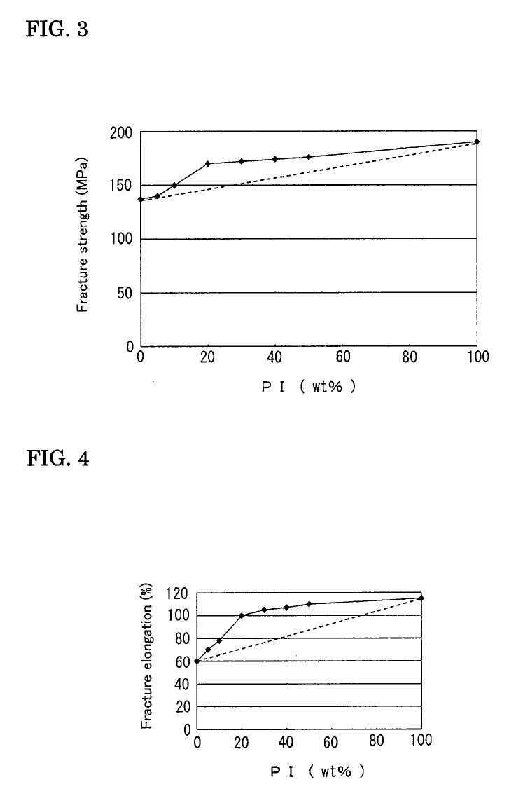

Based on the results shown in Tables I and II, the relationship between the compounding ratio of polyamide acid (polyimide resin varnish), and tensile strength or fracture elongation is shown in FIGS. 1 to 4. In FIGS. 1 to 4, the axis of abscissa represents the compounding ratio of polyamide acid (indicated as P1 (% by weight) in the figures), and the axis of ordinate represents tensile strength (Unit: MPa) or fracture elongation (%).

As shown in FIGS. 1 to 4, when about 50% by weight of polyamide acid is blended, excellent tensile strength and fracture elongation can be obtained which are comparable, in terms of values, to those obtained when polyamide acid only was used (100% by weight: Comparative Example 1). Also when the proportion of polyamide acid is 50% by weight or lower, favorable values far exceeding expected values (indicated by the dotted line in figures) obtained by proportional division based on the compounding ratio are observed.

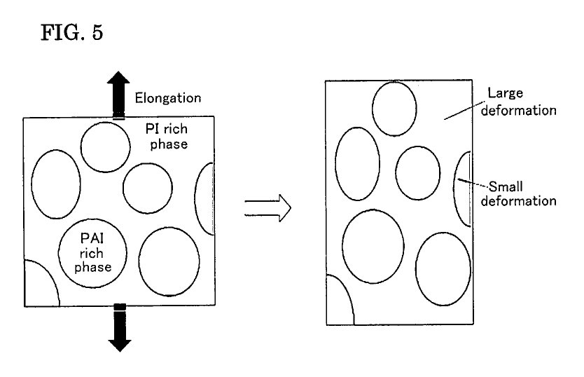

When the obtained heat-resistant resin films are analyzed using scanning probe microscopy, a sea-island structure is confirmed. It is presumed that, by the sea-island structure, an effect of increasing toughness achieved by the present invention is demonstrated. The sea-island structure is shown in FIG. 5.

More specifically, as illustrated in FIG. 5, it is presumed that, at the time of elongation, the sea phase (in which polyimide is rich) sharply deforms, which increases fracture elongation, and, in contrast, the island phase (in which polyamide-imide is rich) demonstrates a reinforcing effect, which increases tensile strength.

1. A heat-resistant resin varnish, comprising:
polyamide-imide resin whose terminal isocyanate functional group is blocked with a blocking agent, and
polyamide acid.

2. The heat-resistant resin varnish according to claim 1, wherein the number average molecular weight of the polyamide-imide resin is 10,000 or more.

3. The heat-resistant resin varnish according to claim 1, wherein the content of the polyamide-imide resin is 5 to 50% by weight relative to the total content of the polyamide-imide resin and the polyamide acid.

4. The heat-resistant resin varnish according to claim 1, wherein the viscosity at 30° C. is 200,000 mPa·s or lower.

5. A heat-resistant resin film,
comprising a cured product in which the heat-resistant resin varnish according to claim 1 has been baked,
the film being in the form of a film or a tube.

6. A heat-resistant resin composite, comprising:
a substrate: and
the heat-resistant resin film according to claim 5.

7. An insulated wire, comprising:
a wire, and
an insulating coating film covering the surface of the wire,
the insulating coating film containing at least one insulating layer formed by applying the heat-resistant resin varnish according to claim 1 to the wire directly or through an insulating layer containing another insulating coating film material, and baking the resultant.

8. The insulated wire according to claim 7, wherein the cross sectional shape of the wire is a hexagonal shape or a rectangular shape.
